(19) United States
(12) Patent Application Publication
(10) Pub. No.: US 2026/0039599 A1
(43) Pub. Date: Feb. 5, 2026

(54) TOKEN INJECTION IN PACKET HEADERS TO SUPPORT HIGH VOLUME PACKET FILTERING

(71) Applicant: Akamai Technologies, Inc., Cambridge, MA (US)

(72) Inventors: Stuart Malin, Atlantis, FL (US); Russell White, Louisburg, TN (US)

(21) Appl. No.: 18/792,968

(22) Filed: Aug. 2, 2024

(51) Int. Cl. H04L 47/215; H04L 47/19; H04L 61/4511

(52) U.S. Cl. CPC H04L 47/215; H04L 47/196; H04L 61/4511

(57) ABSTRACT

A class of network packets can be labeled by inserting a token into a packet header field. Preferably the header field is available to intermediary devices in cleartext. A packet filter examines the packets, allowing packets with the token to pass while dropping others. For example, the token can indicate that the packet is part of a “trusted” class. The token can be calculated from a secret, shared between the sender and receiver, and a rotating value. In some embodiments, the token may be placed in all packets associated with a trusted sender or for some time before trust must be re-established. Alternatively, the token can be placed in an initial one or more packets of a particular flow, and the packet filter can look for such packet(s), deciding whether to allow or block them. The packet filter then treats subsequent packets in the same flow in the same way.

### BACKGROUND

### Technical Field

This patent document generally relates to computer networking, and to the inspection, analysis and filtering of network traffic.

### Brief Description of the Related Art

Packet filtering is a widely used technique to protect websites, API endpoints, and other online properties from unauthenticated, unauthorized, abusive or unwanted traffic. Today, packet filtering is implemented in a wide array of hardware and software, from operating system kernels to firewalls to large-scale scrubbing centers (an example of the latter being described in U.S. Pat. No. 7,478,429, titled “Network Overload Detection And Mitigation System And Method” and published 2009 Jan. 13, the teachings of which are hereby incorporated by reference).

The ability to filter packets at high volume is important, particularly when used in large-scale multi-tenant environments and/or to defend against volumetric attacks. However, trust establishment (e.g., authentication, authorization, bot or bad actor detection) often occurs at the application layer, or to some extent at the TLS layer. Filtering packets at higher layers is computationally expensive because it typically requires decryption and/or deep packet inspection. It is more efficient to filter packets at lower levels in the network stack. For example filtering can be performed more efficiently based on IP headers, or based on TCP or UDP packet headers. But such filtering solutions do not have visibility into higher layer trust mechanisms.

Application or other higher layer trust mechanisms might be configured to label or tag traffic as “trusted” in a way visible to the lower layers of the stack. While a good first step, an attacker will seek to learn and replicate the attributes of the trusted traffic and thereby evade packet filtering.

The teachings hereof disclose systems and methods for enabling efficient packet filtering based on trust establishment occurring outside of the packet filtering process. The teachings hereof further address the need to accomplish such filtering in a secure manner, one that prevents or minimizes attackers' ability to impersonate trusted packets.

The teachings presented herein improve the functioning of a computer system itself, improving the function of network components as well as that of a larger distributed systems and network infrastructure. Those skilled in the art will understand these and other improvements from the teachings hereof.

### BRIEF SUMMARY

This section describes some pertinent aspects of this invention. Those aspects are illustrative, not exhaustive, and they are not a definition of the invention. The claims of this issued patent define the scope of protection.

A class of network packets can be labeled by inserting a token into a header field. Preferably the header field is available in cleartext so that intermediary devices (e.g., a packet filter) can locate and identify the field. The header field might be a cleartext field in an IP header or an unencrypted TCP header, for example. The packet filter examines the field to find the token, validates it, and allows packets with a valid token to pass while dropping others. In this way, the token can indicate that the packet is part of a “trusted” class of packets. To reduce the chance of a token being maliciously spoofed or copied, the token can be calculated from a secret, shared between the sender and receiver, and a rotating value. In some embodiments, the token may be placed in all packets from a trusted sender. Alternatively, the token can be placed in one or more packet(s) that occur at the beginning of a new communication flow, such as a TCP SYN or QUIC ‘client hello’, and the packet filter can look for such types of packets. The packet filter decides whether to pass or discard the initial packet (or set of packets) in the flow. Then it treats subsequent packets in the same packet flow (which may be packets in the same network session) in the same way. That is, if the initial packet(s) are determined to be “trusted”, then the packet filter can pass not only that packet(s) but also subsequent packets in the same flow without needing to validate the token in every packet. If the token is not present in the initial packet(s), the packet filter can block that packet and subsequent packets in the flow, if any.

The claims are incorporated by reference into this section, in their entirety.

### BRIEF DESCRIPTION OF THE DRAWINGS

The invention will be more fully understood from the following detailed description taken in conjunction with the accompanying drawings, in which:

FIG. 1 is a block diagram providing a high-level illustration of a solution consistent with the an implementation of the teachings hereof; and,

FIG. 2 is a block diagram illustrating hardware in a computer system that may be used to implement the teachings hereof.

Numerical labels are provided in some FIGURES solely to assist in identifying elements being described in the text; no significance should be attributed to the numbering unless explicitly stated otherwise.

### DETAILED DESCRIPTION

The following description sets forth embodiments of the invention to provide an overall understanding of the principles of the structure, function, manufacture, and use of the methods and apparatus disclosed herein. The systems, methods and apparatus described in this application and illustrated in the accompanying drawings are non-limiting examples; the claims alone define the scope of protection that is sought. The features described or illustrated in connection with one exemplary embodiment may be combined with the features of other embodiments. Such modifications and variations are intended to be included within the scope of the present invention. All patents, patent application publications, other publications, and references cited anywhere in this document are expressly incorporated herein by reference in their entirety, and for all purposes. The term “e.g.” used throughout is used as an abbreviation for the non-limiting phrase “for example.”

The teachings hereof may be realized in a variety of systems, methods, apparatus, and non-transitory computer-readable media. It should also be noted that the allocation of functions to particular machines is not limiting, as the functions recited herein may be combined or split amongst different hosts in a variety of ways.

Any reference to advantages or benefits refer to potential advantages and benefits that may be obtained through practice of the teachings hereof. It is not necessary to obtain such advantages and benefits in order to practice the teachings hereof.

Basic familiarity with well-known web page, streaming, and networking technologies and terms, HTTP all versions, QUIC, MQTT, TCP/IP, and UDP, is assumed.

All references to HTTP should be interpreted to include an embodiment using encryption (HTTP/S), such as when TLS secured connections are established. While context may indicate the hardware or the software exclusively, should such distinction be appropriate, the teachings hereof can be implemented in any combination of hardware and software. Hardware may be actual or virtualized.

### DISCUSSION

With the foregoing by way of introduction, detailed description of the embodiments is now provided.

Modern network security architectures often include the use of some sort of packet filter between a sender (e.g., a client application) and a receiver (e.g, a server). Packet filters are currently available in a wide array of products and services, including firewalls, gateways, routers, and intrusion detection systems, and network scrubbing centers.

An efficient way to filter packets is for the sender to insert a piece of data—a token—into the packet stream and to use the presence or absence of a token to drive decisions on filtering actions. A packet filter examines traffic, matching it against a tuple (e.g., a five-tuple such as: source and destination IP address, source and destination TCP/UDP port, and IP protocol) so each packet is classified into a well-defined application flow. If the token is not present in a given packet, or is present but invalid, the packet filter can drop that packet or all packets in the flow.

There are various ways to provision the sender with the token for injection into the packets. For example, a developer can code a client application to place a token into a given field in an IP header (such as a private IPv6 extension header). The token (or precursor material) can be obtained by registering with a provisioning process associated with the receiver, or otherwise in an out of band process. The client application then embeds that token into the packet header fields it sends to the receiver. Alternatively, the sender might obtain the token (or precursor material) dynamically, as part of a trust establishment process, for example an application layer authentication or authorization routine. Upon successfully establishing trust with the client application and/or end user, the server provides the client application with the token. The scope of the token can be limited to the client application or an organization associated therewith.

As suggested above, it is preferable that the system provide the sender not with an actual token itself, but with precursor data from which a token is calculated, such as a secret that will be shared between sender and packet filter. Token generation will be described in more detail below.

There are multiple ways to enhance the packet filter to improve its efficiency and ability to process packets at high speed.

For example, the packet filter can locate and validate the token only in the initial packet (or set of packets) of a particular packet flow, such as those at the start of a TCP flow (e.g, a TCP SYN packet at the beginning of a TCP handshake), or a UDP flow (e.g., a QUIC client hello. Another example is to include the token in a DNS query. Note that the token need not be in a packet header, it could be in the payload of the packet.

Once a flow is established, the packet(s) belonging to the flow can be identified by a tuple as previously mentioned. Hence the packet filter can treat all packet(s) in the flow in the same way: if the token in the initial packet(s) is valid, pass the packets in the same flow, if not present or invalid, all subsequent packets in the same flow are dropped. This avoids the need to perform token validation on every single packet of a flow.

Second, the token can be placed in a cleartext field. This means that the field itself is unencrypted and is not obfuscated, then any suitably configured network intermediary can locate the field, and extract the token from it, without requiring access to TLS keys or the like. The packet filter does not need to decrypt the TLS layer to obtain the token, nor does it need to perform deep packet inspection at the application layer. The packet filter can efficiently locate the token and then validate the authenticity of the value as a valid token.

The field itself being unencrypted does not necessarily mean that the precursor data used to create the token is in the clear or somehow to eavesdroppers. That data can remain private. Nevertheless, a downside of placing the token in a cleartext field is that any intermediary can locate that field and identify the token, even if the value of the token itself is the result of an encryption/hash/obfuscation of other precursor data that remains private. Hence, an attacker also can see the token, and thus duplicate the token and place it in malicious traffic.

To combat such an attack, the value of the token (or of precursor material used to create the token) can be changed from time to time (referred to as rotating the value). For example, the token can be generated based on a function of a secret obtained upon trust establishment and a public key obtained from a public server, such as a DNS server. To generate a token, a client application queries a DNS server to obtain the current public key. It combines this value with the secret to generate the token which it embeds in the packet header. Periodically, the DNS rotates the public key. Hence, while an attacker can see the token value and attempt to replicate it in malicious packets, the ruse will fail once the public key is rotated. The packet filter is also provided with the same information, or with a pre-computed token from the precursor data, so that it can validate tokens.

It should be understood that the aforementioned token rotation can be periodic, e.g., every few minutes, aperiodic, or event-based, e.g., based on traffic volumes or observed anomalies. Rotation may occur on a packet by packet basis.

The public key may be served with a time to live (TTL) indicating when the client should re-query for a new public key. The public server may also be configured with security measures designed to prevent malicious actors from transacting with it to obtain the current public key, such as bot detection and IP reputation checks, IP spoofing protection, client certificate authentication, or other known techniques. The publica server may require connection establishment, which also provides some measure of protection.

### Generating the Token and Public Key

In general, token generation takes precursor material and mathematically generates a token value from them in a non-reversible way. Preferably token generation involves applying known cryptographic functions such as an MD5 hash. An example function to generate the token takes the form of:

$$token = one - way - hash ( secret + public key )$$

The public key can be generated using pseudo-random number generators starting with a seed according to a timestamp or other value, or other known techniques.

Another approach is for both the sender and packet filter side to use a synchronized current time value or current epoch. In this approach, token generation involves combining the secret with the current timestamp (or epoch). Preferably the current timestamp or epoch is used as a seed value for a pseudo-random number generator. The packet filter performs the same calculation with the same seed value so that it can check the value against the token in the packet to validate the token. Naturally the time changes on both client and packet filter, thwarting the attacker's attempt to replicate the token. Known techniques for synchronization of network clocks, such as network time protocol (NTP), and correction for clock drift can be used with this approach. In this approach, a random salt value may be incorporated into the token generation function for added security.

In yet another embodiment, the secret can be periodically rotated. This may be accomplished via an out of band process between the sender and receiver.

Note that absolute security is not necessary in all embodiments. A reasonably secure token that enables the packet filter to largely (if not entirely) identify “malicious” traffic can provide efficiency gains, even if an attacker is able to copy and use a token for a limited period of time. Other security and attack mitigation components can be introduced inline to address malicious traffic that leaks through the packet filter. Indeed, the use of an expired token—one based on an expired public key—can be used as an indicator of a malicious actor.

### Diagram

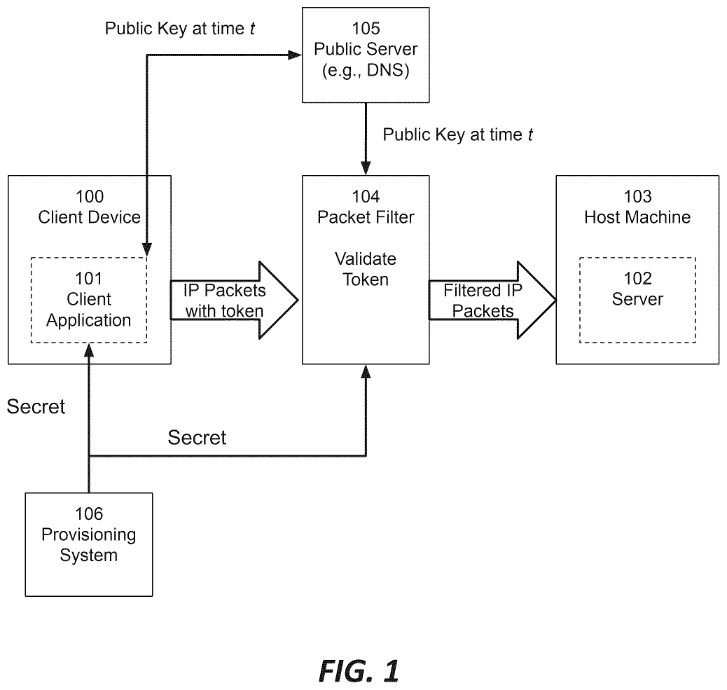

FIG. 1 provides a high-level illustration of a solution consistent with the foregoing description of embodiments. The sender is a client application 101, a piece of software running on client device 100 (e.g., laptop, mobile device, or the like). The receiver is a server application 102 hosted on a physical or virtual machine 103 in a data center. The packet filter 104 is a combination of hardware and software and may be deployed as an intermediary (e.g., as a proxy, scrubbing center or the like) and/or co-located with the receiver.

The provisioning system 106 enables a client developer to register and obtain a secret, which can be embedded into the developer's client application 101. (Or for the client application 101 to obtain a secret dynamically.) As shown and previously described, the client application 101 then generates tokens and embeds them into outbound packets. The secret may be unique to the particular client application 101 or the developer's enterprise (customer). The provisioning system provides the secret for this client application to the packet filter 104.

The public server 105 serves as a widely available source of the public key. Client application 100 can query the server 105 for the current public key at the time during which it wants to send packets. The public server 105 serves the value of the public key at request time t. The public server 105 can also distribute this value to the packet filter 104. Alternatively, the provisioning system 106 or other components can generate and distribute the public key. Or the public server 105 and packet filter 104 can independently generate the public key independently but with synchronization.

### Computer Based Implementation

The teachings hereof may be implemented using conventional computer systems, but modified by the teachings hereof, with the components and/or functional characteristics described above realized in special-purpose hardware, general-purpose hardware configured by software stored therein for special purposes, or a combination thereof, as modified by the teachings hereof.

Software may include one or several discrete programs. Any given function may comprise part of any given module, process, execution thread, or other such programming construct. Generalizing, each function described above may be implemented as computer code, namely, as a set of computer instructions, executable in one or more microprocessors to provide a special purpose machine. The code may be executed using an apparatus—such as a microprocessor in a computer, digital data processing device, or other computing apparatus—as modified by the teachings hereof. In one embodiment, such software may be implemented in a programming language that runs in conjunction with a proxy on a standard Intel hardware platform running an operating system such as Linux. The functionality may be built into the proxy code, or it may be executed as an adjunct to that code.

While in some cases above a particular order of operations performed by certain embodiments is set forth, it should be understood that such order is exemplary and that they may be performed in a different order, combined, or the like. Moreover, some of the functions may be combined or shared in given instructions, program sequences, code portions, and the like. References in the specification to a given embodiment indicate that the embodiment described may include a particular feature, structure, or characteristic, but every embodiment may not necessarily include the particular feature, structure, or characteristic.

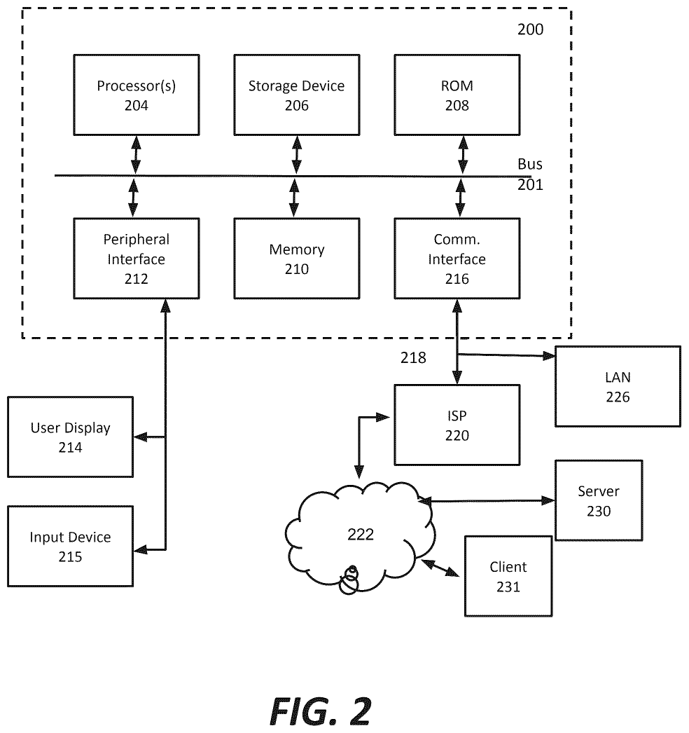

FIG. 2 is a block diagram that illustrates hardware in a computer system 200 upon which such software may run in order to implement embodiments of the invention. The computer system 200 may be embodied in a client device, server, personal computer, workstation, tablet computer, mobile or wireless device such as a smartphone, network device, router, hub, gateway, or other device. Representative machines on which the subject matter herein is provided may be a computer running a Linux or Linux-variant operating system and one or more applications to carry out the described functionality.

Computer system 200 includes a microprocessor 204 coupled to bus 201. In some systems, multiple processor and/or processor cores may be employed. Computer system 200 further includes a main memory 210, such as a random access memory (RAM) or other storage device, coupled to the bus 201 for storing information and instructions to be executed by processor 204. A read only memory (ROM) 208 is coupled to the bus 201 for storing information and instructions for processor 204. A non-volatile storage device 206, such as a magnetic disk, solid state memory (e.g., flash memory), or optical disk, is provided and coupled to bus 201 for storing information and instructions. Other application-specific integrated circuits (ASICs), field programmable gate arrays (FPGAs) or circuitry may be included in the computer system 200 to perform functions described herein.

A peripheral interface 212 may be provided to communicatively couple computer system 200 to a user display 214 that displays the output of software executing on the computer system, and an input device 215 (e.g., a keyboard, mouse, trackpad, touchscreen) that communicates user input and instructions to the computer system 200. However, in many embodiments, a computer system 200 may not have a user interface beyond a network port, e.g., in the case of a server in a rack. The peripheral interface 212 may include interface circuitry, control and/or level-shifting logic for local buses such as RS-485, Universal Serial Bus (USB), IEEE 1394, or other communication links.

Computer system 200 is coupled to a communication interface 216 that provides a link (e.g., at a physical layer, data link layer,) between the system bus 201 and an external communication link. The communication interface 216 provides a network link 218. The communication interface 216 may represent an Ethernet or other network interface card (NIC), a wireless interface, modem, an optical interface, or other kind of input/output interface.

Network link 218 provides data communication through one or more networks to other devices. Such devices include other computer systems that are part of a local area network (LAN) 226. Furthermore, the network link 218 provides a link, via an internet service provider (ISP) 220, to the Internet 222. In turn, the Internet 222 may provide a link to other computing systems such as a remote server 230 and/or a remote client 231. Network link 218 and such networks may transmit data using packet-switched, circuit-switched, or other data-transmission approaches.

In operation, the computer system 200 may implement the functionality described herein as a result of the processor executing code. Such code may be read from or stored on a non-transitory computer-readable medium, such as memory 210, ROM 208, or storage device 206. Other forms of non-transitory computer-readable media include disks, tapes, magnetic media, SSD, CD-ROMs, optical media, RAM, PROM, EPROM, and EEPROM, flash memory. Any other non-transitory computer-readable medium may be employed. Executing code may also be read from network link 218 (e.g., following storage in an interface buffer, local memory, or other circuitry).

It should be understood that the foregoing has presented certain embodiments of the invention but they should not be construed as limiting. For example, certain language, syntax, and instructions have been presented above for illustrative purposes, and they should not be construed as limiting. It is contemplated that those skilled in the art will recognize other possible implementations in view of this disclosure and in accordance with its scope and spirit. The appended claims define the subject matter for which protection is sought.

It is noted that any trademarks appearing herein are the property of their respective owners and used for identification and descriptive purposes only, and not to imply endorsement or affiliation in any way.

1. A method performed at one or more devices that perform packet filtering on packets sent from a sender to a receiver over one or more networks, the method comprising:
receiving a packet going from to sender to a receiver, the packet as received having a field identifiable in cleartext;
examining the packet to locate the field and to extract a token therefrom;
validating the token, comprising:
determining that the token matches an expected value, which is a function of (i) a secret associated with the sender, and (ii) a current value of data element that is available to the sender, the data element changing in value over time; and,
filtering the packet based at least in part on the validation, the filtering being one of:
upon determining that the token is valid, passing the packet towards the receiver, and
upon failing to determine that the token is valid, at least one of: blocking the packet and generating an alert.

2. The method of claim 1, wherein the field of the packet comprises a header field associated with any of the following network protocols: an IP protocol, a TCP protocol, a UDP protocol, a QUIC protocol.

3. The method of claim 1, wherein the current value of the data element is publicly available.

4. The method of claim 1, wherein the current value of the data element is publicly available from a DNS server.

5. The method of claim 1, further comprising, prior to said examination of the packet:
determining that the packet is associated with a beginning of a transport layer flow between sender and receiver, and based at least in part on that determination, performing said examination of the packet to locate the field and extract the token; and,
filtering subsequent packets in the transport layer flow in accord with the determination of the token's validity, irrespective of whether tokens are present in the subsequent packets in the transport layer flow.

6. The method of claim 1, further comprising, prior to said examination of the packet:
upon successful trust establishment between sender and receiver, the one or more devices taking at least one of the following actions: (a) providing the secret to the sender, and (b) instructing the sender to insert the token into the field.

7. The method of claim 6, wherein the trust establishment process comprises at least one of:
a sender authentication process,
a sender authorization process,
a sender challenge.

8. The method of claim 1, wherein the token represents a value that has been hashed.

9. A packet filtering system comprising a client device, a packet filter, and one or more servers;
a client device configured to:
execute a trust establishment process with one or more servers, and, upon successful completion of the trust establishment process, receive a secret shared between the client and the one or more servers;
obtain a current value of a data element, the data element changing in value over time;
generate a token based at least in part on a function of the secret and the current value of the data element;
insert the token into a field of a packet, the client device sending the field identifiable in cleartext to the one or more servers; and,
a packet filter that receives the packet, examines the packet to locate the field and to extract the token therefrom, and determines how to filter the packet based at least in part on the validity of the token.

10. The system of claim 9, wherein the field of the packet with the token comprises a header field associated with any of the following network protocols: an IP protocol, a TCP protocol, a UDP protocol, a QUIC protocol.

11. The system of claim 9, wherein the client device obtains the current value of the data element from a public source.

12. The system of claim 9, wherein the client device obtains the current value of the data element from a DNS server.

13. The system of claim 9, wherein the trust establishment process comprises at least one of:
a sender authentication process,
a sender authorization process,
a sender challenge.

14. The system of claim 9, wherein the packet filter determines that the packet is associated with a beginning of a transport layer flow between the client and one or more servers, and based at least in part on that determination, the packet filter determines to perform said examination of the packet to locate the field and extract the token, and determines how to filter the packet based at least in part on the validity of the token.

15. The system of claim 14, the packet filter configured to filter subsequent packets in the transport layer flow in accord with the determination of the token's validity, irrespective of whether tokens are present in the subsequent packets in the transport layer flow.

16. A non-transitory computer readable medium holding computer program instructions for execution on at least one hardware processor, the computer program instructions including instructions that upon execution cause at least one computer to perform steps comprising:
receiving a packet going from to sender to a receiver, the packet as received having a field identifiable in cleartext;
examining the packet to locate the field and to extract a token therefrom;
validating the token, comprising:
determining that the token matches an expected value, which is a function of (i) a secret associated with the sender, and (ii) a current value of data element that is available to the sender, the data element changing in value over time; and,
filtering the packet based at least in part on the validation, the filtering being one of:
upon determining that the token is valid, passing the packet towards the receiver, and
upon failing to determine that the token is valid, at least one of: blocking the packet and generating an alert.

17. The non-transitory computer readable medium of claim 16, wherein the field of the packet comprises a header field associated with any of the following network protocols: an IP protocol, a TCP protocol, a UDP protocol, a QUIC protocol.

18. The non-transitory computer readable medium of claim 16, wherein the current value of the data element is publicly available.

19. The non-transitory computer readable medium of claim 16, the steps further comprising, prior to said examination of the packet:
determining that the packet is associated with a beginning of a transport layer flow between sender and receiver, and based at least in part on that determination, performing said examination of the packet to locate the field and extract the token; and,
filtering subsequent packets in the transport layer flow in accord with the determination of the token's validity, irrespective of whether tokens are present in the subsequent packets in the transport layer flow.

20. The non-transitory computer readable medium of claim 16, the steps further comprising, prior to said examination of the packet:
upon successful trust establishment between sender and receiver, taking at least one of the following actions: (a) providing the secret to the sender, and (b) instructing the sender to insert the token into the field.

21. The non-transitory computer readable medium of claim 16, wherein the trust establishment process comprises at least one of:
a sender authentication process,
a sender authorization process,
a sender challenge.
